(19) United States
(12) Patent Application Publication
(10) Pub. No.: US 2009/0002308 A1
(43) Pub. Date: Jan. 1, 2009

(54) LIGHT EMISSION CONTROL APPARATUS AND LIQUID CRYSTAL DISPLAY APPARATUS INCLUDING THE SAME

(75) Inventor: Ritsuo Yoshida, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/135,924

(22) Filed: Jun. 9, 2008

(30) Foreign Application Priority Data
Jun. 29, 2007 (JP) 2007172825

(51) Int. Cl. G09G 3/36; G02F 1/13357

(52) U.S. Cl. 345/102

(57) ABSTRACT

According to one embodiment, a light emission control apparatus controlling light emissions of plural light sources in a light emission device which includes the light sources in respective light source areas and lights a liquid crystal panel using the plural light sources has following sections: an initial value setting section setting initial control values of the plural light sources; an illumination value calculation section calculating an illumination value to illuminate the liquid crystal panel for the respective light source areas based on a spread characteristic of light emitted from the plural light sources, using the initial control values set by the initial value setting section; an additional value determination section determining an additional value to increase an emission intensity of the plural light sources when an illumination value of the light source areas corresponding to screen areas of the liquid crystal panel is smaller than a maximum display value for the respective screen areas, the additional value being determined based on a difference between the maximum display value and the illumination value; and a control value determination section correcting the initial control value according to the additional value determined by the additional value determination section and determining a light source control value to emit light from the light sources.

### CROSS-REFERENCE TO RELATED APPLICATIONS

This application is based upon and claims the benefit of priority from Japanese Patent Application No. 2007-172825, filed Jun. 29, 2007, the entire contents of which are incorporated herein by reference.

### BACKGROUND

1. Field

One embodiment of the invention relates to a light emission control apparatus for controlling a light emission of a light emission device such as a backlight illuminating a liquid crystal panel and the like, and a liquid crystal display apparatus including the light emission control apparatus.

2. Description of the Related Art

A liquid crystal display apparatus is now used as an image display in a television, a personal computer, a mobile phone, and the like. In the liquid crystal display apparatus, a liquid crystal panel itself does not emit light and a backlight is provided back of the liquid crystal panel and illuminates from backside of the liquid crystal panel to display images.

A liquid crystal display apparatus is known, which has a backlight, and each light source constituting the backlight and a display screen are corresponded to each other and divided into plural areas and an area control for controlling each light source is executed for every display screen areas (screen areas).

Regarding this type of the liquid crystal display apparatus, for example, Japanese Patent Application Laid-Open No. 2007-34251 (Patent Document 1) discloses a liquid crystal display apparatus. In this liquid crystal display apparatus, a light emission luminance of each light source is calculated based on a display luminance detected in view of an influence of the screen area of the light source, which is not corresponding to the screen area. Then the correction amount for the respective picture elements of the display is calculated based on a most desirable display luminance based on a difference between the light emission luminance of each light source and an optimal display brightness in each display screen.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary exploded perspective diagram showing a configuration of a liquid crystal display apparatus 100 according to an embodiment of the invention;

FIG. 2 is an exemplary perspective diagram showing a configuration of a light emission area in the embodiment;

FIG. 3 is an exemplary perspective diagram showing a light emitter and a liquid crystal panel with a correspondence between light source areas and screen areas in the embodiment;

FIG. 4 is an exemplary block diagram showing a configuration of a backlight controller with a backlight, the liquid crystal panel and a display value corrector in the embodiment;

FIG. 5 is an exemplary flowchart showing an example of a control value determination procedure in the embodiment; and

FIG. 6 is an exemplary diagram schematically showing a spread characteristic of light emitted from the light source in the embodiment.

### DETAILED DESCRIPTION

Various embodiments according to the invention will be described hereinafter with reference to the accompanying drawings. In general, according to one embodiment of the invention, a light emission control apparatus controlling light emissions of plural light sources in a light emission device which includes the light sources in respective light source areas and lights a liquid crystal panel using the plural light sources has following sections: an initial value setting section setting initial control values of the plural light sources; an illumination value calculation section calculating an illumination value to illuminate the liquid crystal panel for the respective light source areas based on a spread characteristic of light emitted from the plural light sources, using the initial control values set by the initial value setting section; an additional value determination section determining an additional value to increase an emission intensity of the plural light sources when an illumination value of the light source areas corresponding to screen areas of the liquid crystal panel is smaller than a maximum display value for the respective screen areas, the additional value being determined based on a difference between the maximum display value and the illumination value; and a control value determination section correcting the initial control value according to the additional value determined by the additional value determination section and determining a light source control value to emit light from the light sources.

Further, a liquid crystal display apparatus includes a liquid crystal panel, a light emission device lighting the liquid crystal panel using light sources provided in respective light source areas, and a light emission control device controlling a light emission of the light sources. The light emission control device has a an initial value setting section setting initial control values of the plural light sources; an illumination value calculation section calculating an illumination value to illuminate the liquid crystal panel for the respective light source areas based on a spread characteristic of light emitted from the plural light sources, using the initial control values set by the initial value setting section; an additional value determination section determining an additional value to increase an emission intensity of the plural light sources when the illumination value of the light source areas corresponding to screen areas of the liquid crystal panel is smaller than a maximum display value for the respective screen areas, the additional value being determined based on a difference between the maximum display value and the illumination value; and a control value determination section correcting the initial control value according to the additional value determined by the additional value determination section and determining a light source control value emit light from the light sources.

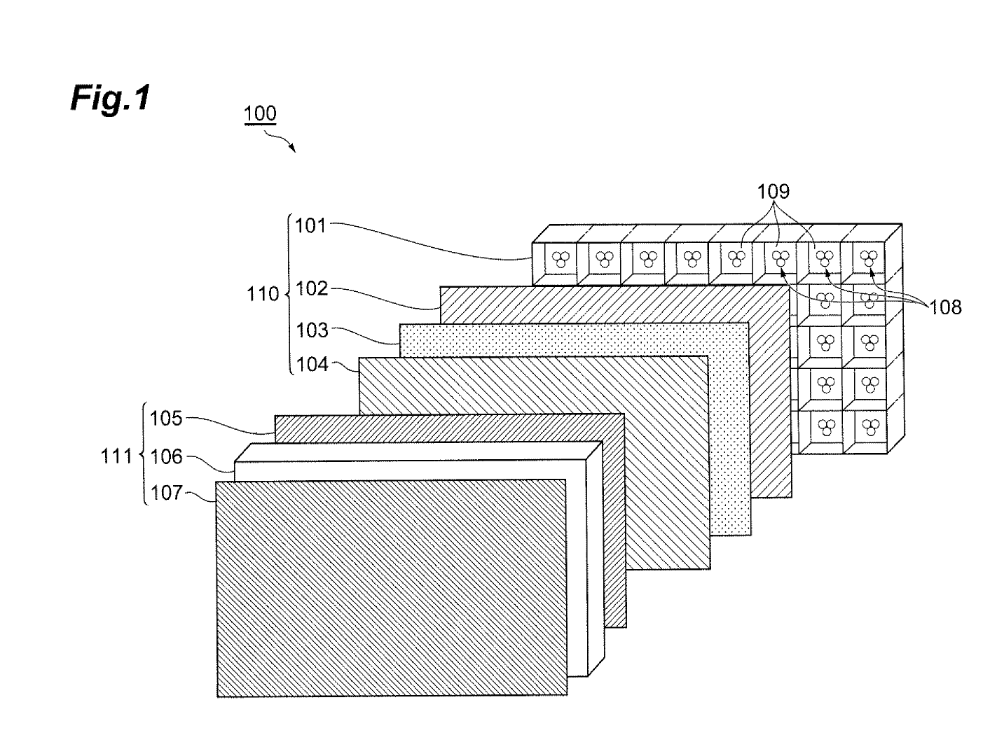

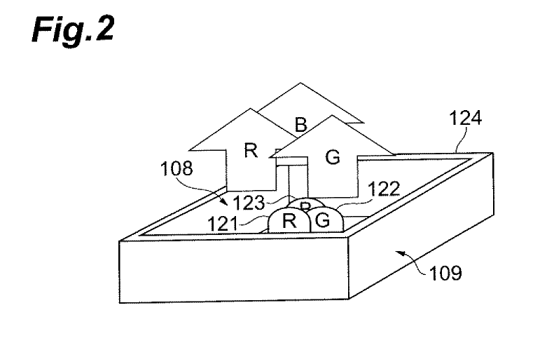

A configuration of a liquid crystal display apparatus 100 according an embodiment of the present invention will be described with reference to FIGS. 1 and 2. FIG. 1 is an exploded perspective view showing the configuration of the liquid crystal display apparatus 100 according to the embodiment of the present invention and FIG. 2 is a perspective view showing a configuration of a light source area and a light source.

The liquid crystal display apparatus 100 is applied to a liquid crystal television and the like and includes a backlight 110 and a liquid crystal panel 111 as shown in FIG. 1.

The backlight 110 has a light emitter (light emission device) 101 and a pair of diffuser plates 102, 104 as sandwiching a prism sheet 103 in front of the light emitter 101.

The light emitter 101 is formed in a panel shape and has a matrix structure in which plural light source areas 109 are regularly arranged in “m” lines and “n” columns in vertical and horizontal directions. FIG. 1 shows the light emitter 101 in which the light source areas 109 are arranged in 5 lines and 8 columns as an example.

The light source area 109 is surrounded in four directions by partition walls 124 extending in a stacking direction of the diffuser plate 102 and the like, as shown in FIG. 2.

In the respective light source areas 109, a light source 108 composed of three LEDs 121, 122, 123 of RGB primary colors is disposed. The light source 108 includes the red LED 121, green LED 122 and blue LED 123 and emits light forward (toward the liquid crystal panel 111) as mixing the three colors of read, green and blue. The emitted light of the respective light source areas 109 illuminates the back of the liquid crystal panel 111 and the transmission of the emitted light in the liquid crystal panel 111 is adjusted to display an image.

The liquid crystal display apparatus 100 is a direct lighting type apparatus in which the whole area of the backlight 110 emits light using the plural light sources 108 in the respective light source areas 109 to illuminate the back of the liquid crystal panel 111.

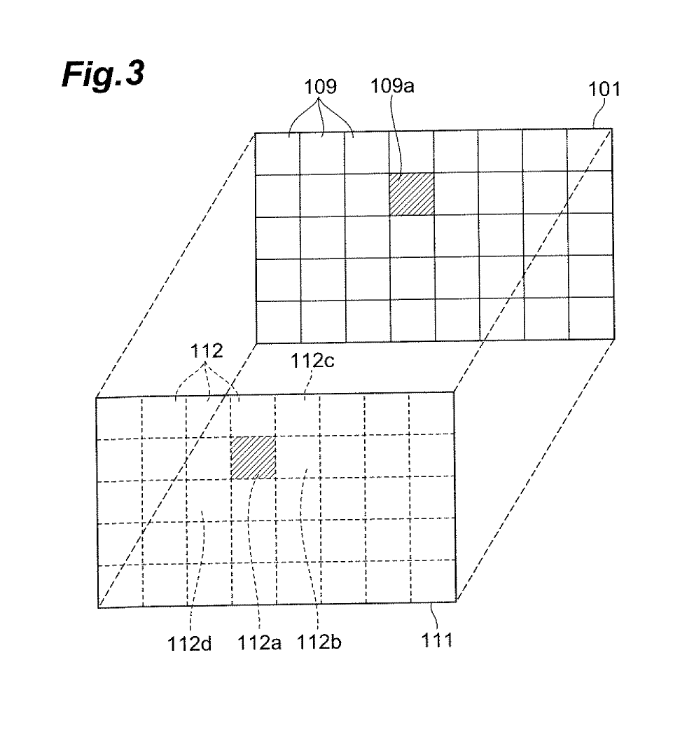

The liquid crystal panel 111 includes a pair of polarizing plates 105, 107 and a liquid crystal 106 disposed between the polarizing plates 105, 107. According to the present embodiment, as shown in FIG. 3, the liquid crystal panel 111 has screen areas 112 which are areas corresponding to the respective light source areas 109.

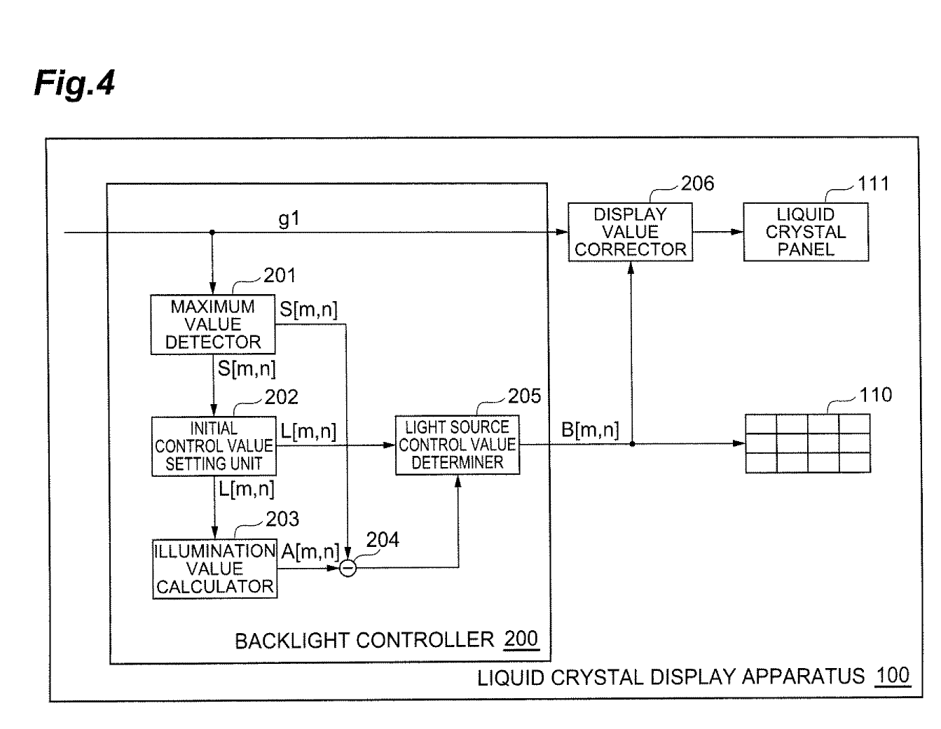

A configuration of a backlight controller 200 will be described with reference to FIG. 4. FIG. 4 is a block diagram showing the configuration of the backlight controller 200 with the backlight 110 and the liquid crystal panel 111.

The backlight controller 200 is included in the liquid crystal display apparatus 100 together with the backlight 110, the liquid crystal panel 111 and a later described display value corrector 206.

The backlight controller 200 includes a maximum value detector 201, an initial control value setting unit 202, an illumination value calculator 203, a comparator 204 and a light source control value determiner 205. Detail functions of those elements will be explained later in a description related to the operation.

The display value corrector 206 corrects an image display signal g1 used to display an image on the liquid crystal panel 111 according to a later-described light source control value from the light source control value determiner 205 and outputs the signal.

The backlight controller 200 inputs the image display signal g1 used to display an image on the liquid crystal panel 111 and determines a light source control value based on the image display signal g1 to control light emissions of the backlight 110.

Firstly, the maximum value detector 201 extracts an area, which is made to emit brightest light among the screen areas 112, from the screen areas 112 according to the image display signal g1 and sets a control value (maximum display value) S[m,n] corresponding to the extracted area. The set maximum display value S[m,n] is output to the initial control value setting unit 202 and the comparator 204.

Here, “m” is a positive integer from 1 to M, which indicates a line number of the screen area 112 (corresponding light source area 109) and “n” is a positive integer from 1 to N, which indicates a column number of the screen area 112 (corresponding light source area 109). The “M” is a maximum line number and the “N” is a maximum column number.

The initial control value setting unit 202 sets an initial control value L[m,n] of the control target light source area (target light source area) 109 using the maximum display value S[m,n] for the respective screen areas 112. The initial control value L[m,n] indicates how much light the light source 108 is made to emit and shows a value that is 0, 1 or between 0 and 1.

The initial control value setting unit 202 sets initial control values of the light source areas 109 placed around the target light source area 109, as described below.

In this case, to consider light reflected by the partition wall 124, the initial control value setting unit 202 obtains a control value L1[m,n] by multiplying the control value L[m,n] of the target light source area 109 by a reflectance R(R≦1) and sets the obtained control value L1[m,n] as the initial control values L[m,n] of the neighboring light source areas 109 placed around the target light source area 109.

In this case, the initial control value setting unit 202 sets a range of 1 line and 1 column when a later-described Prof_filter is set as 3 lines and 3 columns, and a range of 2 lines and 2 columns when the Prof_filter is set as 5 lines and 5 columns.

Then, the illumination value calculator 203 executes an operation as an illumination value calculation section. The illumination value calculator 203 obtains an illumination value A[m,n] from the control value L[m,n], which is set in the initial control value setting unit 202, using a two-dimensional FIR filter Prof_filter. The illumination value A[m,n] is a parameter used to make the light source 108 of the light source area 109 emit light to illuminate the screen area 112.

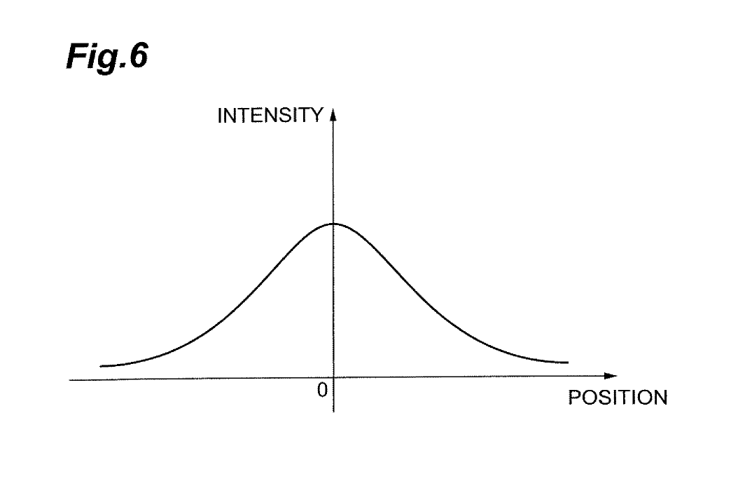

Here, the Prof_filter has a coefficient previously determined based on a spread characteristic of the light emitted from the light source 108. The emitted light from the light source 108 has a spread characteristic to spread to its periphery although the light strength reduces as spreading away from the center toward periphery as shown in FIG. 6, for example.

The light emitted from the light source 108 reaches not only to the screen area 112 corresponding to the light source area 109 of the light source 108 but also to the screen areas 112 placed around the corresponding screen area 112. For example, the light emitted from the light source 108 placed in light source area 109a which is in the 2nd line and 4th column shown in FIG. 3 reaches not only to the screen area 112a corresponding to (placed in right front of) the light source area 109a but also to the peripheral screen areas 112b, 112c, 112d. The emitted light leaks to the peripheral screen areas so that the light emitted from the respective light sources 108 influence each other. Thus, it is required to determine the control value in view of the peripheral emitted light.

Since the spread characteristic of the emitted light is unique in each backlight 110, in the present embodiment, the spread characteristics of the respective light source 108 are obtained in advance and the illumination value is calculated based on the spread characteristics. The illumination value A[m,n] is obtained by Equation 1.

A[m,n]=prof_filter (L[m,n]) Equation 1

The illumination value A[m,n] obtained by Equation 1 reflects not only the emitted light of the light source 108 of the target light source area 109 but also the emitted light of the peripheral light sources 108 around the light source 108.

Then, the comparator 204 compares the illumination value A[m,n] and a maximum display value S[m,n] of each area.

Further, the light source control value determiner 205 determines light source control values B[m,n] of the respective light sources 108 using Equation 2 according to the comparison result in the comparator 204.

In this case, when the maximum display value S[m,n] is greater then the illumination value A[m,n], in other words, when the illumination value A[m,n] is smaller than the maximum display value S[m,n] and the brightness is not enough to display the brightest portion, the light source control value determiner 205 executes an operation as an additional value determination section. The light source control value determiner 205 obtains a difference between the maximum display value S[m,n] and the illumination value A[m,n] and multiply the obtained difference by a multiplying factor (feedback gain of the difference) α(α≧1) to determine an additional value C[m,n]. The additional value C[m,n] is a parameter to increase a light emission amount of each of the respective light sources 108 based on the shortfall in the brightness.

Then, the light source control value determiner 205 executes an operation as a control value determination section. The light source control value determiner 205 corrects the initial control value L[m,n] according to the additional value C[m,n] and determines the light source control value B[m,n] to make the respective light sources 108 emit light.

Since the light source control value B[m,n] is larger than the initial control value L[m,n] according to the additional value C[m,n], the light emission amount of the light sources 108 can be increased by making the light sources 108 emit light according to the light source control value B[m,n].

Further, since a brightness to display the brightest portion is maintained when the maximum display value S[m,n] is smaller than the illumination value A[m,n], the initial control value L[m,n] is simply used as the light source control value B[m,n]. Here, the max(X, Y) represents that larger one is selected from X and Y.

B[m,n]=L[m,n]+α×max(S[m,n]−A[m,n], 0) Equation 2

The light source control value B[m,n] can be excess over an upper control value limit (“1”) of the respective light sources 108, which are not multiplied by a particular multiplying factor α. Then, the light source control value B[m,n] is clipped by the upper limit (“1”). With this process, conclusive control values of the respective light sources 108 can be obtained regarding the spread characteristic of light emitted from the light sources 108.

Since the control value of each light source area 109 is obtained as described above, the light emission of the backlight 110 can be controlled. The backlight controller 200 obtains control values to make the light sources 108 of the light source areas 109 emit light based on the above described calculation process, without solving a multiple simultaneous equations like in a conventional liquid crystal display apparatus. Thus, the backlight controller 200 is practical and the respective light sources 108 can be made to emit light according to the obtained control values.

The backlight controller 200 is made to execute an area control with a simple calculation process and the area control does not affect the images to be displayed. Here, since the light sources 108 are made to emit light as much as the brightness required to the image display, the power consumption of the backlight 110 can be reduced.

The backlight controller 200 determines the control values as the following procedure to improve the control value accuracy.

Firstly, regarding the excess value excess the upper limit “1” among the light source control values B[m,n] obtained as described above, the light source control value determiner 205 uses a later-described share_filter to obtain a compensation additional value D[m,n], which is to be added to the control values of the light sources 108 placed around the target light source area 109, according to Equation 3.

When there is an excess value which is excess the upper limit “1” in the light source control value B[m,n], the illumination value of the light source is in a saturation state. This indicates that the light source is not enough to maintain the brightness required to display the image corresponding to the image display signal g1.

When the brightness is deficient, the brightness is required to be compensated by the light emitted from the light sources placed around the target light source area 109. A filter for calculating the emission light to be compensated, that is, a filter for determining the control value to emit light from the light source around the saturated light source, is the share_filter. The additional value obtained using the share_filter is a compensation additional value D[m,n].

Since the share_filter is also unique in each backlight 110 similarly to the above mentioned prof_filter, the share_filter is set according to the previously obtained spread characteristic, according to the present embodiment.

D[m,n]=share_filter(max(B[m,n]−1,0)) Equation 3

Then, the light source control value determiner 205 executes an operation as an add section. The light source control value determiner 205 corrects the light source control value B[m,n] by adding the compensation additional value D[m,n] multiplied by the particular multiplying factor (gain used to distribute load to the emission light to periphery when the light source is saturated) β(β≧1). Then, the upper limit “1” is clipped. In such a case, as shown in Equation 4, a control value of the light source, which is corrected in view of the spread characteristic of the light from the light source, can be obtained. Here, min(X,Y) represents that a smaller one is selected from X and Y.

L[m,n]=min(B[m,n]+β×D[m,n], 1) Equation 4

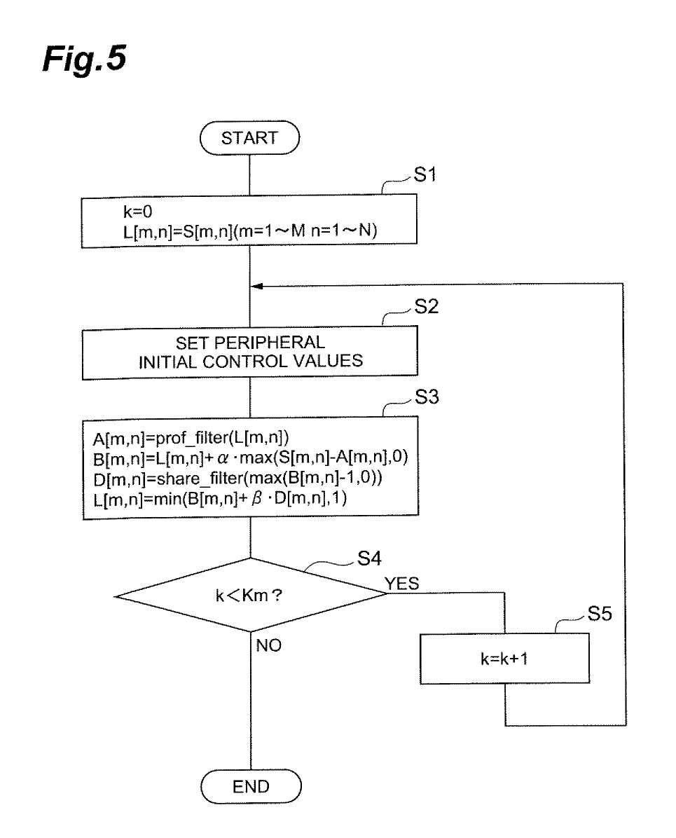

Further, to improve the accuracy in control values, the backlight controller 200 can repeat the series of procedure for correcting the control values according to the flowchart shown in FIG. 5.

Firstly, the backlight controller 200 sets “0” to a counter k in S1 to set the above described maximum display value S[m,n] to the initial control value L[m,n].

Next, in S2, the control value L1[m,n] is obtained as described above and the obtained control value L1[m,n] is set to the initial control values L[m,n] of light source areas 109 placed around the target light source area 109.

Then, in S3, the illumination value A[m,n], light source control value B[m,n] and compensation additional value D[m,n] are obtained as described above and the corrected control value L[m,n] is obtained using Equation 4. Then, the procedure continues to S4.

Here, the counter k is compared with a set value Km that is the number of calculations. Here, when the counter k exceeds the set value Km, the calculation process is ended. When the counter k does not exceeds the set value Km, “1” is added to the counter k in S5 and the procedure returns to S2 to repeat the process. With this procedure, the control value is repeatedly obtained to be close to an ideal value. Thus, the accuracy in the control value is improved. In this case, the above described multiplying factor α, β can be set to be greater values so that the number of repetition can be made 1. In contrast, the factors α, β can be set as lower values so that the number of repetition can be plural.

The forgoing description is the description of the embodiments of the present invention and is not intended to limit apparatuses and methods of the invention, and various modified examples can be easily embodied. Further, an apparatus or a method realized by appropriate combination of the constituent elements, functions, features, or method steps in the embodiments are also included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A light emission control apparatus controlling light emissions of plural light sources in a light emission device which includes the light sources in respective light source areas and lights a liquid crystal panel using the plural light sources, the light emission control apparatus comprising:
an initial value setting section setting initial control values of the plural light sources;
an illumination value calculation section calculating an illumination value to illuminate the liquid crystal panel for the respective light source areas based on a spread characteristic of light emitted from the plural light sources, using the initial control values set by said initial value setting section;
an additional value determination section determining an additional value to increase an emission intensity of the plural light sources when an illumination value of the light source areas corresponding to screen areas of the liquid crystal panel is smaller than a maximum display value for the respective screen areas, the additional value being determined based on a difference between the maximum display value and the illumination value; and
a control value determination section correcting the initial control value according to the additional value determined by said additional value determination section and determining a light source control value to emit light from the light sources.

2. The light emission control apparatus according to claim 1, further comprising
an add section, when the light source control value determined by said control value determination section exceeds an upper limit control value of a relative light source, the add section adding an excess in the light source control value over the upper limit control value to light source control values of peripheral light sources around the relative light source corresponding to the light source control value.

3. The light emission control apparatus according to claim 1, wherein
said illumination value calculation section calculates the illumination value using an FIR filter which indicates the spread characteristic of the emitted light.

4. A liquid crystal display apparatus comprising a liquid crystal panel, a light emission device lighting the liquid crystal panel using light sources provided in respective light source areas, and a light emission control device controlling a light emission of the light sources, wherein
the light emission control device comprising:
an initial value setting section setting initial control values of the plural light sources;
an illumination value calculation section calculating an illumination value to illuminate the liquid crystal panel for the respective light source areas based on a spread characteristic of light emitted from the plural light sources, using the initial control values set by said initial value setting section;
an additional value determination section determining an additional value to increase an emission intensity of the plural light sources when the illumination value of the light source areas corresponding to screen areas of the liquid crystal panel is smaller than a maximum display value for the respective screen areas, the additional value being determined based on a difference between the maximum display value and the illumination value; and
a control value determination section correcting the initial control value according to the additional value determined by said additional value determination section and determining a light source control value emit light from the light sources.

5. A liquid crystal display apparatus according to claim 4, further comprising
a correcting section correcting an image display signal to display an image on the liquid crystal panel according to the light source control value determined by said control value determination section.
